(19) United States
(12) Patent Application Publication
(10) Pub. No.: US 2023/0408790 A1
(43) Pub. Date: Dec. 21, 2023

(54) DRIVE UNIT, LENS DRIVING DEVICE, CAMERA MODULE, AND CAMERA-EQUIPPED DEVICE

(71) Applicants: Shun SUZUKI, Tokyo (JP); Masayoshi SUGAWARA, Tokyo (JP)

(72) Inventors: Shun SUZUKI, Tokyo (JP); Masayoshi SUGAWARA, Tokyo (JP)

(73) Assignee: MITSUMI ELECTRIC CO., LTD., Tokyo (JP)

(21) Appl. No.: 18/252,540

(22) PCT Filed: Oct. 8, 2021
(86) PCT No.: PCT/JP2021/037359

§ 371 Date: May 11, 2023

Related U.S. Application Data
(60) Provisional application No. 63/113,224, filed on Nov. 13, 2020.

(51) Int. Cl. G02B 7/10; G03B 5/02; H02N 2/02

(52) U.S. Cl. CPC G02B 7/102; G03B 5/02; H02N 2/026; G03B 2205/0046; G03B 2205/0061

(57) ABSTRACT

This drive unit comprises: an ultrasonic motor that converts the oscillation of a piezoelectric element to linear movement; a contact part that contacts a resonating part; a support part that is connected to a moveable part and supports the contact part; and an impelling part which is coupled to the contact part and which impels the contact part toward the resonating part so that the contact part moves in accordance with the resonance of the resonating part and transmits impelling force to the moveable part via the support part.

### TECHNICAL FIELD

The present invention relates to a driving unit, a lens driving device, a camera module, and a camera-mounted device.

### BACKGROUND ART

Conventionally, a camera module mounted on a thin camera-mounted device such as a smartphone is known. Such a camera module is known to include a lens driving device having a zoom function for enlarging or downsizing a subject image.

For example, PTL 1 discloses a configuration including a fixed lens on which light from a subject is incident, two movable lenses on which the light deflected by the fixed lens is incident, and a lens driving part for moving the two movable lenses in the direction of the optical axis.

### CITATION LIST

### Patent Literature

PTL 1
Japanese Patent Application Laid-Open No. 2018-36416

### SUMMARY OF INVENTION

### Technical Problem

In the meantime, using an ultrasonic-motor type driving unit has been considered from a viewpoint of miniaturization of a camera-mounted device. In the ultrasonic-motor type driving unit, an active element having a resonant portion and a passive element relatively moving with respect to the active element are in contact with each other in a biased state, and the both elements slide against each other during driving.

Hence, when the positional relationship between the active element and the passive element in a contact portion of the both elements is displaced, a driving condition of the driving unit might vary in accordance with a contact position between the active element and the passive element. That is, the stability of driving performance of the driving unit (ultrasonic motor) decreases due to the displaced positional relationship between the active element and the passive element in the contact portion between the both elements.

An object of the present invention is to provide a driving unit, a lens driving device, a camera module, and a camera-mounted device each capable of improving the stability of driving performance of an ultrasonic motor.

### Solution to Problem

A driving unit according to the present invention is a driving unit for generating a thrust to move a movable part in a predetermined direction, the driving unit including:
an ultrasonic motor that includes a piezoelectric element and a resonant portion and is configured to convert a vibration of the piezoelectric element into a linear motion, the piezoelectric element generating the vibration, the resonant portion resonating with the vibration of the piezoelectric element;
a contacting part that is in contact with the resonant portion;
a supporting portion that is connected to the movable part and is configured to support the contacting part; and
a biasing portion that is engaged with the contacting part and is configured to bias the contacting part toward the resonant portion such that the contacting part moves in accordance with resonance of the resonant portion and transmits the thrust to the movable part via the supporting portion.

A lens driving device according to the present invention includes:
a movable part that is capable of holding a movable lens; and
the above-described driving unit that is configured to drive the movable part in a predetermined direction.

A camera module according to the present invention includes:
the above-described lens driving device;
a lens part that includes the movable lens held by the movable part; and
an image capturing part that is configured to capture a subject image imaged by the lens part, in which
the movable lens is driven in the predetermined direction.

A camera-mounted device according to the present invention is a camera-mounted device that is an information apparatus or a transporting apparatus, the camera-mounted device including:
the above-described camera module; and
an image capturing control part that processes image information obtained by the camera module.

### Advantageous Effects of Invention

According to the present invention, it is possible to improve the stability of driving performance of an ultrasonic motor.

### BRIEF DESCRIPTION OF DRAWINGS

FIG. 1A illustrates a smartphone in which a camera module is mounted;

FIG. 1B illustrates the smartphone in which the camera module is mounted;

FIG. 2 schematically illustrates a camera module according to an embodiment of the present invention;

FIG. 3 schematically illustrates a configuration of the camera module as seen in a side view according to the present embodiment;

FIG. 4 is a perspective view illustrating a housing portion of the camera module;

FIG. 5 is a perspective view of a bottom wall portion side of the housing portion of the camera module;

FIG. 6 is an exploded perspective view of a housing and a lens part;

FIG. 7 is an exploded perspective view of the side wall portion and the bottom wall portion of the housing;

FIG. 8 illustrates the housing as seen from the +side in the Z-direction;

FIG. 9 illustrates an inside of the housing as seen from the −side in the X-direction;

FIG. 10 illustrates a guided portion;

FIG. 11 illustrates a connecting portion between the lens part and a frame;

FIG. 12 is an exploded perspective view of the guided portion and an interposition part;

FIG. 13A is a diagram for describing a positional relationship between a magnet and a position detection part;

FIG. 13B is another diagram for describing the positional relationship between the magnet and the position detection part;

FIG. 13C is still another diagram for describing the positional relationship between the magnet and the position detection part;

FIG. 14 illustrates an arrangement relationship between the interposition part and an ultrasonic motor;

FIG. 15 is a perspective view of the ultrasonic motor;

FIG. 16 is an exploded perspective view of the ultrasonic motor;

FIG. 17 is an enlarged view of a contact portion between a resonant portion and the interposition part;

FIG. 18 is a perspective view of the interposition part;

FIG. 19 is an exploded perspective view of the interposition part;

FIG. 20 illustrates the interposition part as seen from the side of a biasing member;

FIG. 21 is a side view of the interposition part;

FIG. 22 is a diagram for describing an assembled state of the biasing member;

FIG. 23 illustrates the interposition part as seen from the side of a plate-shaped member;

FIG. 24A illustrates an automobile in which the camera module is mounted; and

FIG. 24B illustrates the automobile in which the camera module is mounted.

### DESCRIPTION OF EMBODIMENTS

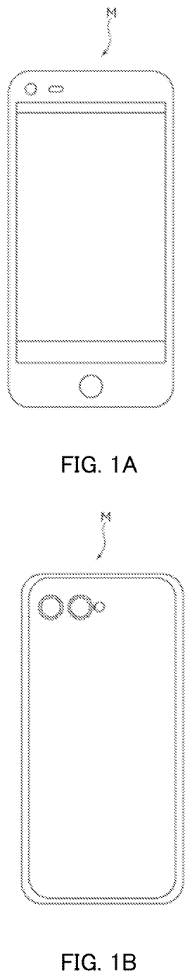

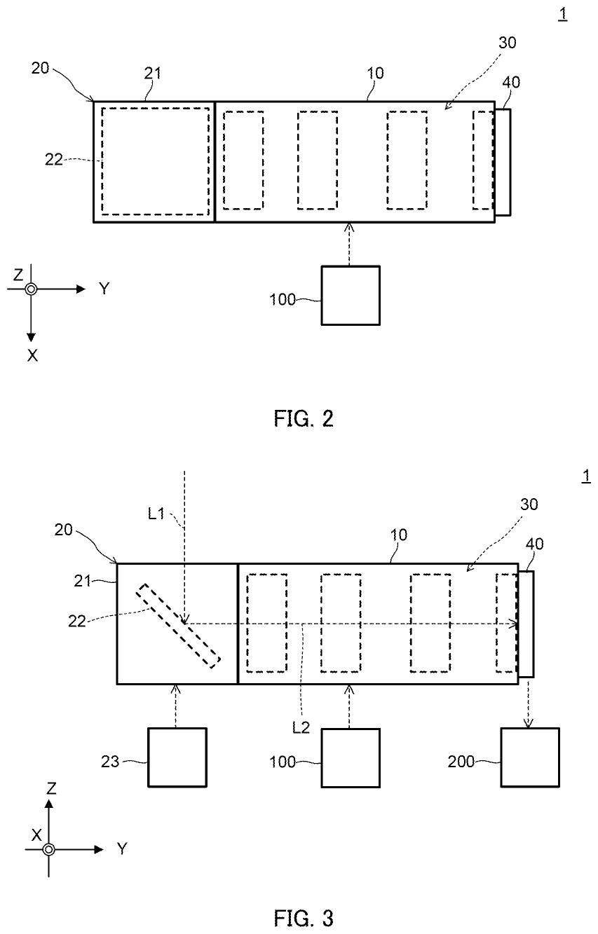

Hereinafter, an embodiment of the present invention will be described in detail with reference to the drawings. FIG. 1A illustrates a smartphone in which a camera module is mounted. FIG. 1B illustrates the smartphone in which the camera module is mounted. FIG. 2 schematically illustrates camera module 1 according to an embodiment of the present invention. FIG. 3 schematically illustrates a configuration of camera module 1 as seen in a side view according to the present embodiment.

As illustrated in FIG. 1A and FIG. 1B, camera module 1 is mounted on a thin camera-mounted device such as, for example, smartphone M, a mobile phone, a digital camera, a notebook personal computer, a tablet terminal, a portable game machine, an in-vehicle camera, or the like.

In describing the structure of camera module 1 of the present embodiment, an orthogonal coordinate system (X, Y, Z) is used. The same orthogonal coordinate system (X, Y, Z) is also used for illustration of below-mentioned figures. Camera module 1 is mounted such that the horizontal direction is the X-direction, the vertical direction is the Y-direction, and the front-rear direction is the Z-direction, for example, during actually capturing an image with a camera-mounted device. Light from a subject is incident from the −side (minus side) in the Z-direction, and is deflected and guided to the +side (plus side) in the Y-direction. By reducing the thickness of camera module 1 in the Z-direction, it is possible to reduce the thickness of the camera-mounted device.

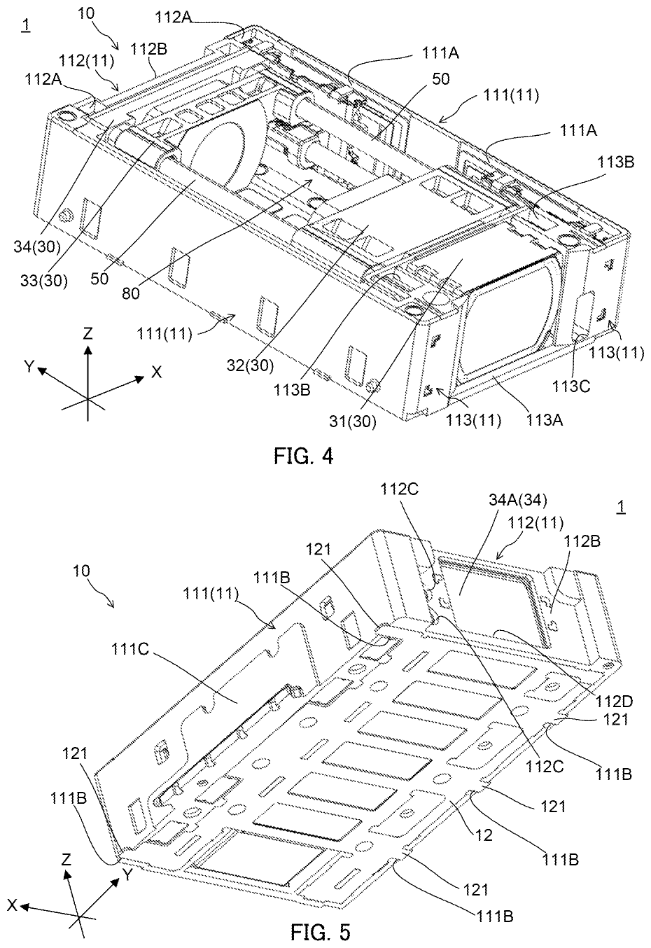

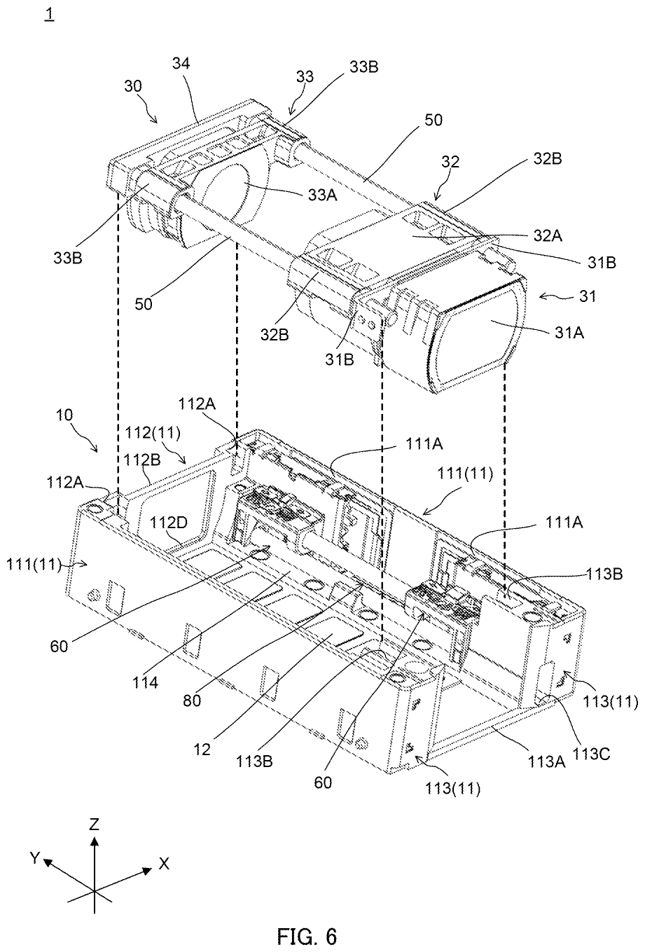

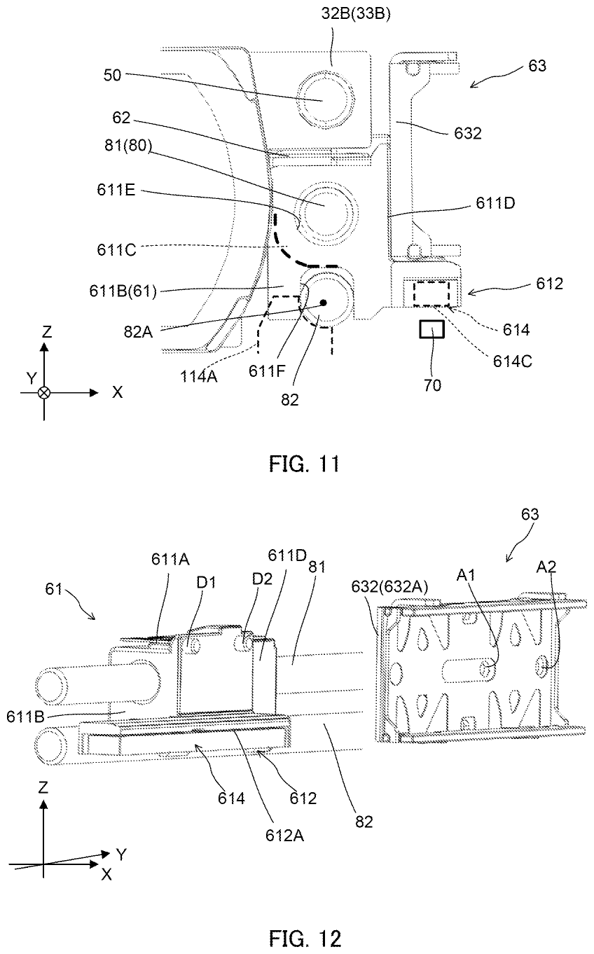

As illustrated in FIG. 2, camera module 1 includes housing 10, reflection driving part 20, lens part 30, image capturing part 40, support shaft 50 (see FIG. 4), lens driving part 60 (see FIG. 6), position detection part 70 (see FIG. 11), and drive control part 100.

Drive control part 100 includes a Central Processing Unit (CPU), Read Only Memory (ROM), Random Access Memory (RAM), or the like. The CPU reads a program suited to processing contents out of the ROM, develops the program in the RAM, and integrally controls an operation of lens driving part 60 in cooperation with the developed program. Thus, drive control part 100 drives, in the Y-direction (direction of optical axis), second lens unit 32 and third lens unit 33 to be described later of lens part 30 housed in housing 10. As a result, camera module 1 performs stepless optical zoom and autofocus. Housing 10, support shaft 50, lens driving part 60, position detection part 70, and drive control part 100 correspond to the “lens driving device” of the present invention.

Further, as illustrated in FIG. 3, in camera module 1, incident light L1 is incident on housing 10 via reflection driving part 20. Reflection driving part 20 includes reflecting housing 21, mirror 22, and reflection drive control part 23. In the example illustrated in FIGS. 2 and 3, reflecting housing 21 is disposed adjacent to an end portion of housing 10 on the −side in the Y-direction. Mirror 22 is provided in reflecting housing 21 and reflects incident light L1 toward housing 10 as reflected light L2. Reflection drive control part 23 includes a CPU, a ROM, a RAM, and the like, and controls the orientation of mirror 22.

Mirror 22 according to the present embodiment has two rotation axes (not illustrated) extending in the X-direction and the Z-direction. In reflection driving part 20, mirror 22 is rotated about the rotation axes under the control of reflection drive control part 23. Thus, camera module 1 has a shake correction function (Optical Image Stabilization (OIS) function) for optically correcting a shake (vibration) that occurs during capturing an image, so as to reduce image irregularities.

Reflected light L2 incident on housing 10 is output to image capturing part 40 via lens part 30 housed in housing 10.

Image capturing part 40 is disposed on the outer surface of housing 10 on the +side in the Y-direction (placement portion 112B of second wall 112 to be described later), and is configured to allow reflected light L2 to be incident thereon through lens part 30. Image capturing part 40 includes an image capturing device, a board, and the like (neither is illustrated).

The image capturing device is composed of, for example, a Charge-Coupled Device (CCD) image sensor, a Complementary Metal Oxide Semiconductor (CMOS) image sensor, or the like. The image capturing device is mounted on the board and electrically connected to the interconnections on the board via bonding wires. The image capturing device captures a subject image imaged by lens part 30 and outputs an electrical signal corresponding to the subject image.

Further, a printed wiring board (not illustrated) is electrically connected to the board of image capturing part 40. The power supply to the image capturing device and the output of the electrical signal of the subject image imaged by the image capturing device are performed via the printed wiring board. The electrical signal is output to image capturing control part 200 provided in the camera-mounted device. Image capturing control part 200 includes a CPU, a ROM, a RAM, and the like, and processes image information obtained by camera module 1. Image capturing control part 200 may be mounted on the camera-mounted device, or may also be built in camera module 1.

As illustrated in FIG. 4, housing 10 houses lens part 30, support shafts 50, and lens driving parts 60 (see also FIG. 6), and for example, has a rectangular parallelepiped shape as a whole. Housing 10 includes side wall portion 11 and bottom wall portion 12.

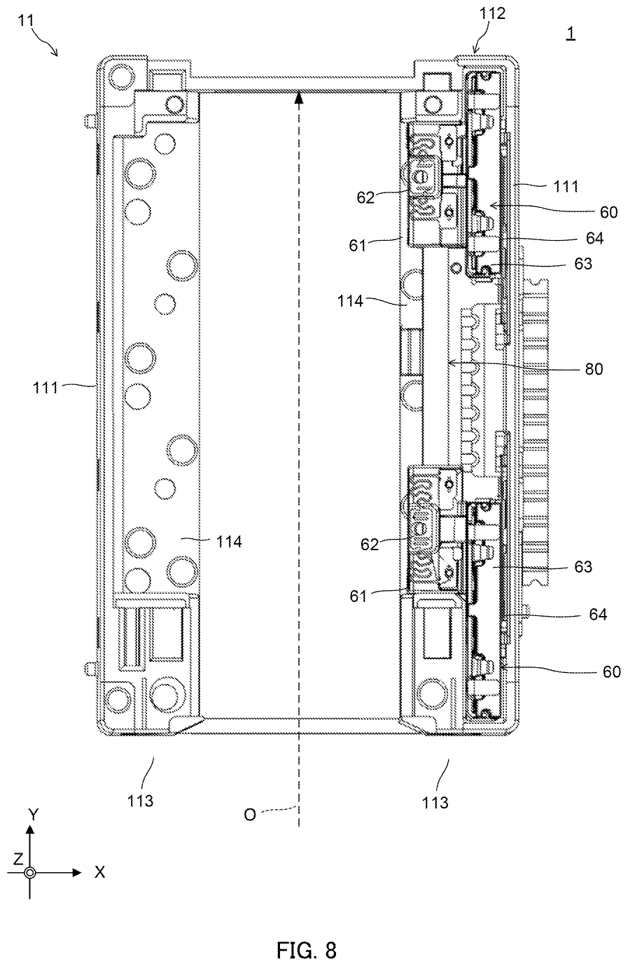

Side wall portion 11 is a wall portion made of, for example, resin and having a portion opening on the −side in the Y-direction, and has first walls 111, second wall 112, third walls 113, and fourth walls 114 (see also FIG. 8 and the like).

A pair of first walls 111 is configured to extend in the Y-direction, and are provided on both sides in the X-direction. Of the pair of first walls 111, the inner surface of first wall 111 of housing 10 on the +side in the X-direction, placement portions 111A on which an ultrasonic motor to be described later is disposed are provided. On one of first walls 111 situated on the +side in the X-direction, placement portions 111A are provided on both sides of the central portion in the Y-direction.

Further, as illustrated in FIG. 5, board placement portion 111C is provided on first wall 111 on the +side in the X-direction. A board (not illustrated) is provided on board placement portion 111C, across the inside and outside of housing 10 via a gap formed between first wall 111 and bottom wall portion 12, for example. A portion of the terminal disposed outside housing 10 is connected to predetermined interconnections of the camera-mounted device.

Further, portions to be engaged (hereinafter, each referred to as engaged portion) 111B with which positioning portions 121 of bottom wall portion 12 are engaged are formed in the bottom surface of first wall 111 (the surface on the −side in the Z-direction).

As illustrated in FIGS. 4 and 5, second wall 112 is configured to extend in the X-direction, and is provided to connect together the end portions of the pair of first walls 111 on the +side in the Y-direction. Further, in portions of the top surface of second wall 112 (surface on the +side in the Z-direction), supporting portions 112A for supporting support shafts 50 are provided on both sides in the X-direction, respectively. Placement portion 112B on which image capturing part 40 is disposed is provided on the outer surface of second wall 112.

Further, guide supporting portions 112C and opening portion 112D are formed in placement portion 112B of second wall 112. In the present embodiment, guide supporting portions 112C are holes for supporting guide shafts 81 and 82 to be described later, and are formed on the −side of opening portion 112D in placement portion 112B in the X-direction. Two guide supporting portions 112C are formed side by side in the Z-direction. Opening portion 112D is an opening in which fourth lens unit 34 of lens part 30 is fitted, and is formed in placement portion 112B at the central portion in the X-direction.

As illustrated in FIGS. 4 and 6, third walls 113 are provided respectively on the end portions of the pair of first walls 111 on the −side in the Y-direction. The pair of third walls 113 is provided to surround a space formed by first wall 111 and second wall 112. Between the pair of third walls 113, a gap large enough for first lens unit 31 of lens part 30 to enter there, and bridging portion 113A for bridging the end portions of respective third walls 113 on the −side in the Z-direction are provided.

Further, supporting portions 113B for supporting support shafts 50 are formed in the top surfaces of the pair of third walls 113 (the surfaces on the +side in the Z-direction). Guide supporting portion 113C for supporting guide shafts 81 and 82 to be described later is formed in the vicinity of a central portion of one of the pair of third walls 113 in the Z-direction.

Guide supporting portion 113C is a long hole configured to have a length in the Z-direction corresponding to the placement range of two guide supporting portions 112C in second wall 112 described above. Guide supporting portion 113C is capable of supporting guide shafts 81 and 82 supported respectively by two guide supporting portions 112C in second wall 112.

As illustrated in FIG. 6, fourth walls 114 form bottom walls of the space formed by first walls 111, third walls 113 corresponding to first walls 111, and second wall 112, and are provided in regions corresponding to third walls 113 in the X-direction (see also FIG. 8). Therefore, a gap is formed between fourth walls 114 on both sides in the X-direction.

As illustrated in FIGS. 5 to 7, bottom wall portion 12 is, for example, a substantially rectangular metal plate forming a bottom wall of housing 10, and is provided like a bridge between fourth walls 114 and the pair of first walls 111 on opposite sides in the X-direction. Bottom wall portion 12 is integrated by insert molding with the bottom portions of side wall portions 11 including the bottom portions of the pair of first walls 111. Further, in order that there is not any portion of bottom wall portion 12 at a portion corresponding to first lens unit 31, an end portion of bottom wall portion 12 on the −side in the Y-direction is cut out.

Positioning portions 121 are formed on the both lateral ends of bottom wall portion 12 in the X-direction. Positioning portions 121 are formed to protrude from the both lateral ends of bottom wall portion 12, and are to be engaged with engaged portions 111B of first wall 111 described above. Thus, it is possible to position bottom wall portion 12 in the Y-direction.

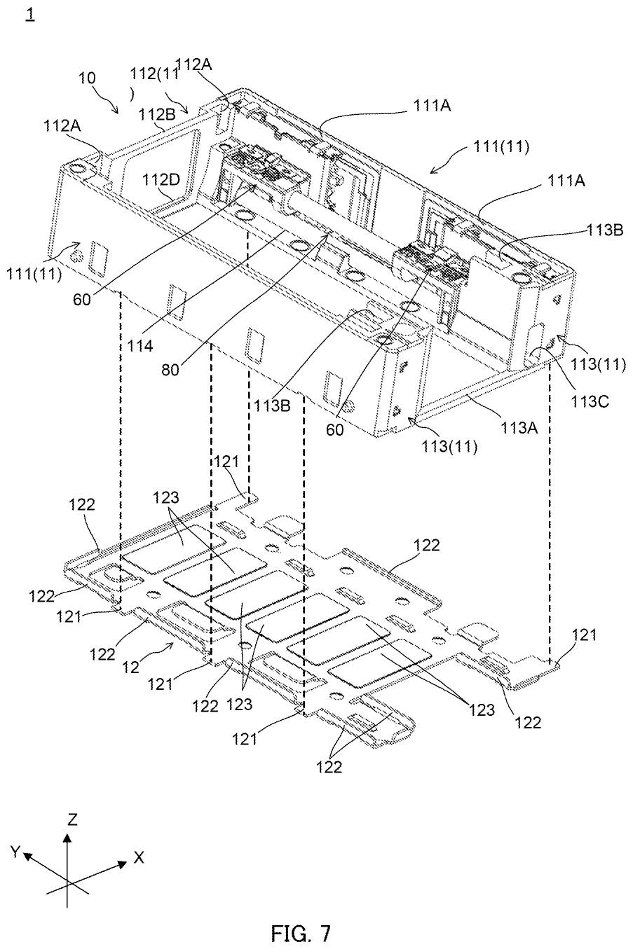

Further, as illustrated in FIG. 7, bent portions 122 are provided on the lateral ends of bottom wall portion 12 in the X-direction and Y-direction. Bent portions 122 are formed by bending the lateral ends to the +side in the Z-direction.

Further, grooves (not illustrated) in which bent portions 122 are fitted are formed in portions of housing 10 corresponding to bent portions 122. Bent portions 122 are fitted in the grooves, and accordingly, bottom wall portion 12 is fixed to housing 10.

Further, a plurality of half punches 123 aligned in the Y-direction are formed in a surface of bottom wall portion 12. Half punches 123 are formed in bottom wall portion 12 over the X-direction. In the present embodiment, a total of six half punches 123 are formed.

Such formation of half punches 123 can improve the strength of the bottom wall portion of housing 10.

As illustrated in FIGS. 4 and 6, lens part 30 is provided in a region that is interposed between the pair of first walls 111 and that includes a region where reflected light L2 from reflection driving part 20 (see FIG. 3) is passed. Lens part 30 includes first lens unit 31, second lens unit 32, third lens unit 33, and fourth lens unit 34 that are disposed side by side in the Y-direction.

First lens unit 31 is disposed on the most upstream side in the incident direction of reflected light L2 (direction toward the +side in the Y-direction) and has body portion 31A and supported portion 31B. Body portion 31A is a portion for holding the lens and is fixed between the pair of third walls 113 in housing 10. Supported portion 31B is a portion supported by support shaft 50 and is provided to protrude from both sides in the X-direction in body portion 31A.

The side surfaces of main body portion 31A are configured to be curved so as to be convex at central portions in the Z-direction, for example. The side surfaces of third wall 113 on the side of main body portion 31A are shaped, for example, to conform the side surfaces of main body portion 31A, and are configured such that the curved portions of main body portion 31A are fitted thereto. Thus, first lens unit 31 is fixed between the pair of third walls 113.

Second lens unit 32 is disposed on the downstream side of first lens unit 31 in the incidence direction, and includes main body portion 32A and supported portions 32B. Third lens unit 33 is disposed on the downstream side of second lens unit 32 in the incidence direction, and includes main body portion 33A and supported portions 33B. Second lens unit 32 corresponds to the “first movable part” of the present invention, and third lens unit 33 corresponds to the “second movable part” of the present invention.

Main body portions 32A and 33A hold a lens through which the light having been passed through first lens unit 31 is passed. Supported portions 32B and 33B are portions movably supported by support shafts 50 and are respectively provided on both sides of main body portions 32A and 33A in the X-direction.

The lens included in main body portion 32A of second lens unit 32 corresponds to the “first movable lens” of the present invention. The lens included in main body portion 33A of third lens unit 33 corresponds to the “second movable lens” of the present invention.

Fourth lens unit 34 is disposed on the most downstream side in the incidence direction, and is configured to include a lens. Fourth lens unit 34 is supported by support shafts 50 at a position adjacent to second wall 112 of housing 10. As illustrated in FIG. 5, in the present embodiment, protruding portion 34A is formed on the surface of fourth lens unit 34 on the +side in the Y-direction.

The lenses in first to fourth lens units 31 to 34 may be assembled to housing 10 when the lens driving device is manufactured, or may be assembled to housing 10 when camera module 1 is manufactured from the lens driving device.

Protruding portion 34A has a size making it possible to be fitted into opening portion 112D in second wall 112. By this protruding portion 34A fitted into opening portion 112D, fourth lens unit 34 is fixed to housing 10.

As illustrated in FIGS. 4 and 6, support shafts 50 are formed of, for example, stainless steel or the like. Support shafts 50 extend in the Y-direction, and are provided respectively in regions of the pair of third walls 113. In the present embodiment, support shafts 50 are formed to have equal lengths, and are supported by supporting portions 113B of third walls 113 and supporting portions 112A of second wall 112.

Lens driving parts 60 are provided to correspond respectively to second lens unit 32 and third lens unit 33, and each of the lens driving parts moves corresponding one of second lens unit 32 and third lens unit 33 independently under the control of drive control part 100 described above. Lens driving part 60 corresponds to the “driving unit” of the present invention.

Lens driving parts 60 are disposed in the region of one of fourth walls 114 on the +side in the X-direction surrounded by first wall 111, second wall 112, and third wall 113. That is, as illustrated in FIG. 8, lens driving parts 60 are disposed in housing 10 on one end side of opposite ends of second lens unit 32 and third lens unit 33 with respect to optical axis O.

In the present embodiment, two lens driving parts 60 are provided side by side in the Y-direction. One of lens driving parts 60 on the −side in the Y-direction drives second lens unit 32 in the Y-direction, and the other one of lens driving parts 60 on the +side in the Y-direction drives third lens unit 33 in the Y-direction. That is, lens driving part 60 on the −side in the Y-direction corresponds to the “first driving unit” of the present invention, and lens driving part 60 on the +side in the Y-direction corresponds to the “second driving unit” of the present invention.

Each of lens driving parts 60 has substantially the same configuration in the present embodiment. Hence, in the following description, unless otherwise stated, only lens driving part 60 corresponding to second lens unit 32 will be described, and lens driving part 60 corresponding to third lens unit 33 will not be described. Further, lens driving parts 60 are symmetrically disposed in the Y-direction in the present embodiment. Hence, the relationship between the +side and the −side in the Y-direction in lens driving part 60 corresponding to third lens unit 33 is reverse with respect to the relationship between the +side and the −side in the Y-direction in lens driving part 60 corresponding to second lens unit 32.

Lens driving part 60 includes frame 61, connecting part 62, interposition part 63, ultrasonic motor 64, and guide part 80.

Frame 61 is connected via connecting part 62 to one of supported portions 32B and 33B of second lens unit 32 and third lens unit 33.

Frame 61 is configured to be movable in the direction of optical axis O by guide part guiding the movement in the direction of optical axis O (Y-direction). Movement of frame 61 in the direction of optical axis O causes second lens unit 32 or third lens unit 33 connected to frame 61 via connecting part 62 to also move along support shafts 50.

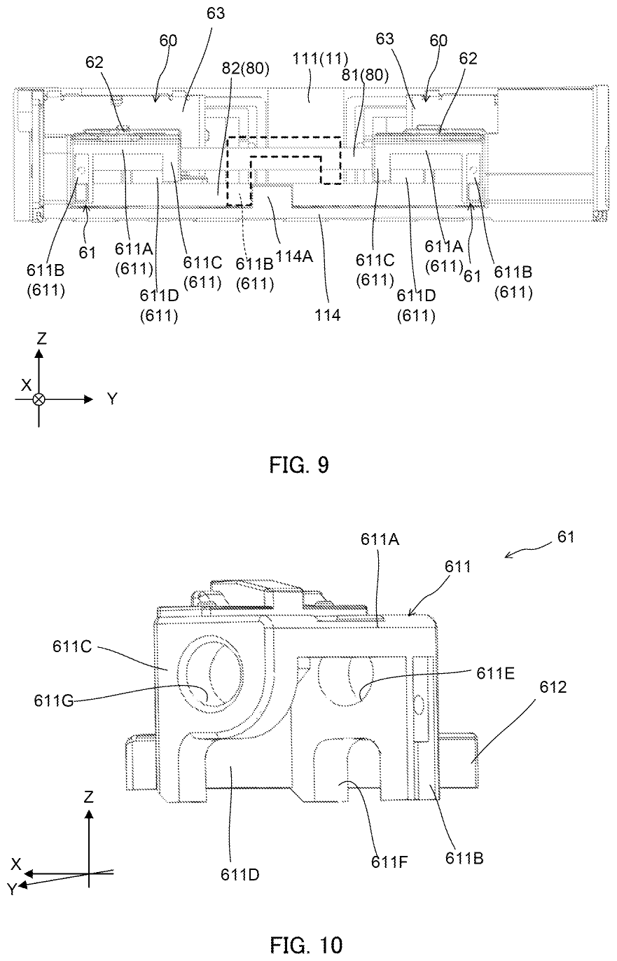

As illustrated in FIGS. 9 and 10, frame 61 includes guided portion 611, and magnet holding portion 612. Guided portion 611 is a portion for guiding the movement of frame 61 by guide part 80 in the Y-direction, and is provided at a position corresponding to guide part in the X-direction. Guided portion 611 includes first portion 611A, second portion 611B, third portion 611C, and fourth portion 611D.

First portion 611A is a portion forming the top surface of frame 61 (surface on the +side in the Z-direction), and is configured to extend in the direction of the optical axis (Y-direction). First portion 611A is provided to cover guide part 80 from the +side in the Z-direction.

Further, connecting part 62 is provided on the surface on the +side of first portion 611A in the Z-direction. As illustrated in FIG. 11, connecting part 62 is a plate-shaped spring member (elastic member) fixed to the surface of frame 61 on the +side in the Z-direction and to the surface of any of supported portions 32B and 33B of second lens unit 32 and third lens unit 33 on the −side in the Y-direction. By connecting part 62 composed of the spring member, the elastic force of the spring member can absorb the displacement of the positional relationship even when manufacturing tolerances or the like cause the displacement in the positional relationship between frame 61 and supported portions 32B and 33B.

As illustrated in FIGS. 9 to 11, second portion 611B extends to the −side in the Z-direction from the end portion of first portion 611A on the −side in the Y-direction (one end of first portion 611A), and supports first guide shaft 81 and second guide shaft 82.

Shaft hole 611E extending through in the Y-direction is formed in second portion 611B. Shaft hole 611E is formed at a position corresponding to first guide shaft 81 to be described later, and allows first guide shaft 81 to be passed therethrough.

Shaft engaging portion 611F is formed in the end portion of second portion 611B on the −side in the Z-direction. Shaft engaging portion 611F is formed at a position where engagement with below-described second guide shaft 82 is possible, and is engaged with second guide shaft 82 from the +side in the Z-direction.

Third portion 611C is a portion that extends to the −side in the Z-direction from the end portion of first portion 611A on the +side in the Y-direction (the other end of first portion 611A), and supports second guide shaft 82. More particularly, third portion 611C extends to a position such that the end portion on the −side in the Z-direction is spaced apart from second guide shaft 82 by a predetermined distance.

Shaft hole 611G extending through in the Y-direction is formed in third portion 611C. Shaft hole 611G is formed at a position corresponding to first guide shaft 81, and allows first guide shaft 81 to be passed therethrough.

Fourth portion 611D is a portion extending from the end portion of first portion 611A on the +side in the X-direction. Fourth portion 611D is formed over entire first portion 611A in the Y-direction, and is disposed to cover guide part 80 from the +side in the X-direction.

As illustrated in FIG. 10, the movement of guided portion 611 is guided by guide part Guide part 80 is disposed in the region of one of fourth walls 114 on the +side in the X-direction that is surrounded by first wall 111, second wall 112, and third wall 113. That is, guide part 80 is disposed in housing 10 on one end side of opposite ends of second lens unit 32 and third lens unit 33 with respect to optical axis O (see also FIG. 8).

Guide part 80 includes first guide shaft 81 and second guide shaft 82, both of which extend in the direction of the optical axis (Y-direction). The first and the second guide shafts are disposed to be spaced apart from each other and cooperate to support both of two frames 61 such that the frames are movable in the direction of the optical axis. First guide shaft 81 and second guide shaft 82 are formed of, for example, stainless steel or the like, and are supported by guide supporting portions (not illustrated) of second wall 112 and third wall 113 of housing 10 at opposite end sides of the optical axis (opposite end sides in the X-direction).

First guide shaft 81 is a guide shaft for guiding the movement of each of frames 61 by supporting second portion 611B and third portion 611C of guided portion 611 of frame 61.

Second guide shaft 82 is a guide shaft disposed parallel to first guide shaft 81 on the −side (fourth wall 114 side) of first guide shaft 81 in the Z-direction, and for guiding the movement of frame 61 by supporting (being engaged with) second portion 611B of guided portion 611 of frame 61. In addition, first guide shaft 81 and second guide shaft 82 are disposed at substantially the same position in the X-direction as one of above-described support shafts (see FIG. 11). As is understood, the two guide shafts, first guide shaft 81 and second guide shaft 82, are provided for guiding the movement of lens driving parts 60. It is thus possible to improve the strength of housing 10.

Second guide shaft 82 is supported by bearing portion 114A provided on fourth wall 114. Bearing portion 114A is provided between two frames 61 to protrude from fourth wall 114 to the +side in the Z-direction, and is disposed in the vicinity of the central portion of second guide shaft 82 in the Y-direction. Second guide shaft 82 is adhesively fixed to bearing portion 114A. Further, bearing portion 114A is disposed in a range including center 82A of second guide shaft 82 in the X-direction (direction between opposite ends with respect to the optical axis) (see FIG. 11).

Further, bearing portion 114A is provided at a position where contact with second portion 611B of frame 61 is possible. Therefore, when frame 61 is moved to the +side in the Y-direction, second portion 611B and bearing portion 114A of frame 61 are brought into contact with each other (see dashed lines in FIG. 9). Thus, bearing portion 114A restricts the movement of frame 61.

As illustrated in FIGS. 11 and 12, magnet holding portion 612 is a portion for holding magnet part 614 for position detection, and extends to the −side in the X-direction from the end portion of fourth portion 611D on the −side in the Z-direction.

Recessed portion 612A is formed in the end portion of magnet holding portion 612 on the −side in the Z-direction, and magnet part 614 is held in the recessed portion. Further, position detection part 70 is provided on a portion of housing 10 facing magnet part 614. Position detection part 70 is, for example, a Hall element for detecting the position of frame 61 in the Y-direction, and detects the position of magnet part 614 based on a predetermined reference position.

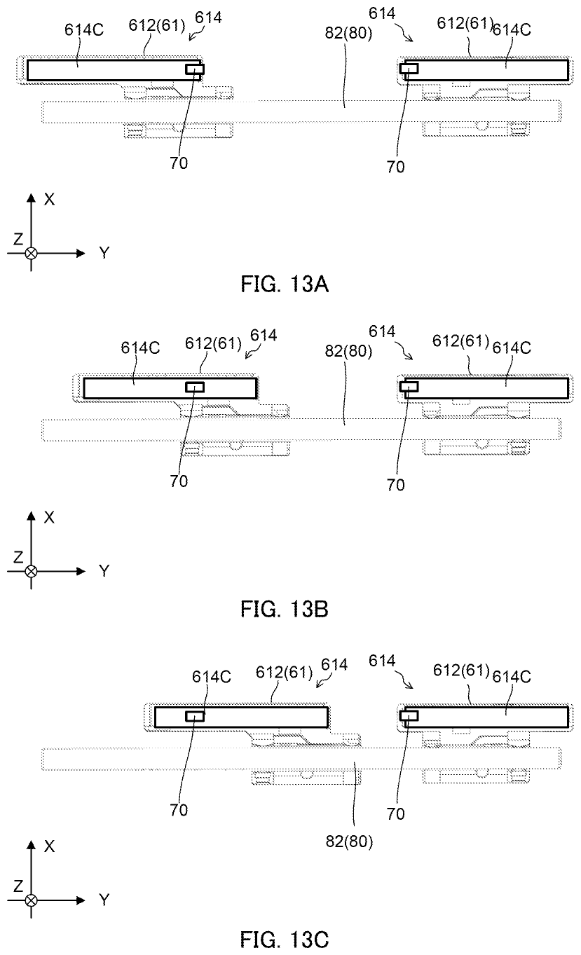

Thus, for example, as illustrated in FIG. 13A, FIG. 13B, and FIG. 13C, as frame 61 on the −side in the Y-direction moves to the +side in the Y-direction, an opposing portion of position detection part 70 with respect to opposing surface 614C varies, for example. Detecting the opposing portion by position detection part 70 makes it possible to detect the position of frame 61.

Further, as illustrated in FIGS. 11 and 12, interposition part 63 is provided above magnet holding portion 612. Interposition part 63 is interposed between frame 61 and ultrasonic motor 64, and is a thrust generation mechanism that generates a thrust to move second lens unit 32 (movable part) in the direction of the optical axis (predetermined direction) based on a driving force of ultrasonic motor 64. Interposition part 63 transmits the thrust to second lens unit 32 by below-described supporting member 632 connected to frame 61.

Two protrusions D1 and D2 are provided on the surface of fourth portion 611D of frame 61 on the +side in the X-direction.

Two protrusions D1 and D2 protrude from the surface of fourth portion 611D and are disposed side by side in the Y-direction. In the present embodiment, protrusion D1 is provided in the vicinity of the end portion of fourth portion 611D on the −side in the Y-direction, and protrusion D2 is provided in the vicinity of the central portion of fourth portion 611D in the Y-direction.

Holes A1 and A2 through which two protrusions D1 and D2 of fourth portion 611D of frame 61 are passed are formed in interposition part 63 (supporting member 632 to be described later). Passing protrusions D1 and D2 through holes A1 and A2 enables the positioning of interposition part 63. Interposition part 63 will be described later in detail.

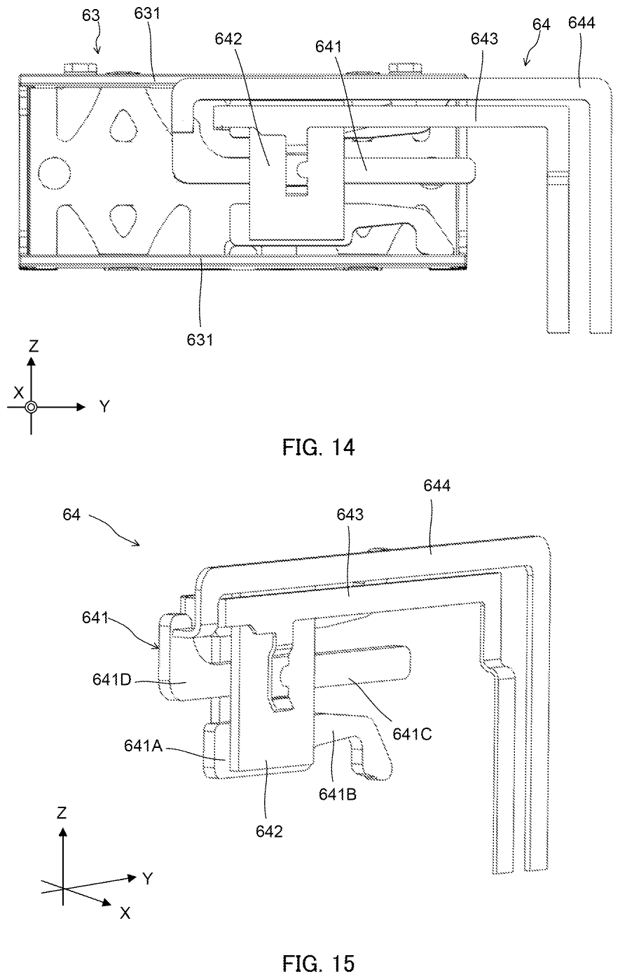

As illustrated in FIGS. 14 and 15, ultrasonic motor 64 is a driving source for generating a driving force for moving frame 61, and is fixedly disposed on each of placement portions 111A of one of first walls 111 on the +side in the X-direction (see FIG. 4 or the like). Ultrasonic motor 64 includes resonant portion 641, piezoelectric elements 642, first electrode 643, and second electrode 644.

Ultrasonic motor 64 on the −side in the Y-direction corresponds to the “first ultrasonic motor” of the present invention, and ultrasonic motor 64 on the +side in the Y-direction corresponds to the “second ultrasonic motor” of the present invention.

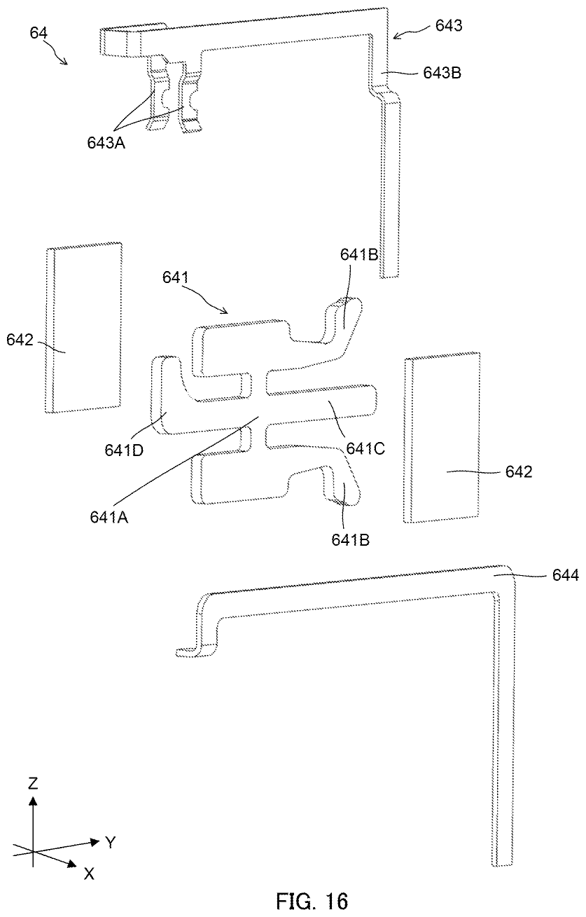

Resonant portion 641 is formed of, for example, a conductive material and resonates with the vibration of piezoelectric elements 642 to convert a vibrational motion into a linear motion of frame 61. Specifically, resonant portion 641 vibrates in an inclination direction inclined with respect to the direction of the optical axis (Y-direction) based on the vibration of piezoelectric elements 642 so as to press interposition part 63 (plate-shaped members 631 to be described below). Accordingly, a thrust to move frame 61 via interposition part 63 in the direction of the optical axis is generated. Resonant portion 641 is disposed to be clamped between two plate-shaped members 631 of interposition part 63. As illustrated in FIG. 16, resonant portion 641 includes body portion 641A, two oscillators 641B, protruding portion 641C, and energization portion 641D.

Body portion 641A is a portion that is clamped by piezoelectric elements 642 and is a portion that is connected to all of two oscillators 641B, protruding portion 641C, and energization portion 641D.

Two oscillators 641B extend in the Y-direction from both sides of body portion 641A in the Z-direction. Two oscillators 641B have symmetrical shapes, and their respective free end portions make contact with plate-shaped members 631 of interposition part 63. The two oscillators 641B respectively correspond to the “first oscillator” and the “second oscillator” of the present invention.

Protruding portion 641C extends to the +side in the Y-direction from body portion 641A. Energization portion 641D extends to the side opposite to protruding portion 641C (the −side in the Y-direction) from body portion 641A.

Each of piezoelectric elements 642 is, for example, a vibration element formed of a ceramic material in a plate shape, and generates a vibration by application of a high-frequency voltage. Two piezoelectric elements 642 are provided to clamp body portion 641A of resonant portion 641 in the X-direction, respectively.

First electrode 643 includes clamping portion 643A for clamping resonant portion 641 and piezoelectric elements 642, and electrode portion 643B to which a voltage is applied. Via clamping portion 643A for clamping piezoelectric elements 642 and the like, first electrode 643 applies a voltage to piezoelectric elements 642. Second electrode 644 is electrically connected to energization portion 641D of resonant portion 641. First electrode 643 and second electrode 644 make contact with the above-described board of board placement portion 111C, inside housing 10.

Two piezoelectric elements 642 are bonded to body portion 641A of resonant portion 641 and are held in between by first electrode 643, so that these are electrically connected to one another. For example, one side of a power supply path is connected to first electrode 643, and the other side is connected to second electrode 644. A voltage is applied to piezoelectric elements 642, and a vibration is thus generated.

Resonant portion 641 has at least two resonant frequencies, and deforms in behaviors different between the resonant frequencies. In other words, the entire shape of resonant portion 641 is set such that resonant portion 641 deforms in behaviors different between the two resonant frequencies. The different behaviors mean behaviors of moving frame 61 to the +side and to the −side in the Y-direction via interposition part 63.

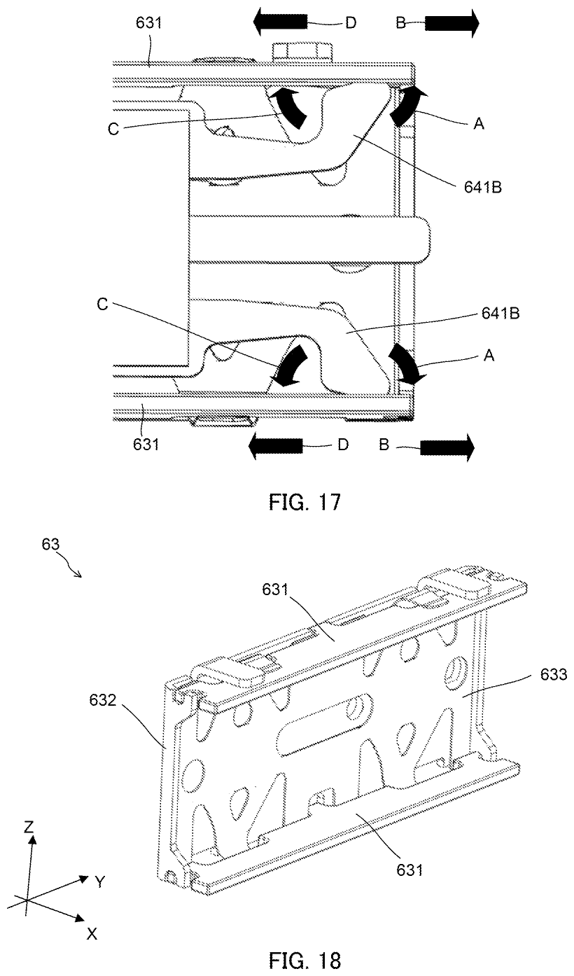

As illustrated in FIG. 17, resonant portion 641 is disposed such that either of the pair of plate-shaped members 631 of interposition part 63 and oscillators 641B face each other. Thus, when two oscillators 641B are deformed, the tip ends of oscillators 641B press (see arrows A) plate-shaped members 631 in a direction inclined with respect to the Y-direction from the opposing sides of plate-shaped members 631.

When plate-shaped members 631 are pressed in the directions of arrows A by the tip ends of oscillators 641B, reaction forces returning on the oscillators 641B sides are generated at plate-shaped members 631. In other words, interposition part 63 generates a reaction force in a direction from the outside of the pair of plate-shaped members 631 toward the inside based on the contact between oscillators 641B and the pair of plate-shaped members 631.

By the reaction force of interposition part 63 with respect to the press of oscillators 641B, the friction generated between oscillators 641B and plate-shaped members 631 causes a thrust in the Y-direction in interposition part 63. Accordingly, the thrust for movement in the Y-direction is applied to frame 61 to be bonded to interposition part 63 (see arrows B). As a result, second lens unit 32 or third lens unit 33 connected to frame 61 is moved in the Y-direction.

Further, plate-shaped members 631 are configured to extend in the Y-direction as described later. When pressed against oscillators 641B, plate-shaped members 631 move in the Y-direction while making sliding contact with oscillators 641B. Therefore, plate-shaped members 631 are continuously pressed by oscillators 641B. Thus, frame 61 to be bonded to interposition part 63 can be moved continuously in the Y-direction. Note that, at a certain resonant frequency, the pressing directions of oscillators 641B are the directions of arrows A and the sliding direction of plate-shaped members 631 is the direction of arrows B, whereas at another resonance frequency, the pressing directions of oscillators 641B are the directions of arrows C and the sliding direction of plate-shaped members 631 is the direction of arrows D.

Such driving operation is performed by each of ultrasonic motors 64 provided on each of first walls 111 on both sides in the X-direction. That is, ultrasonic motors 64 respectively drive second lens unit 32 and third lens unit 33 independently in the direction of the optical axis.

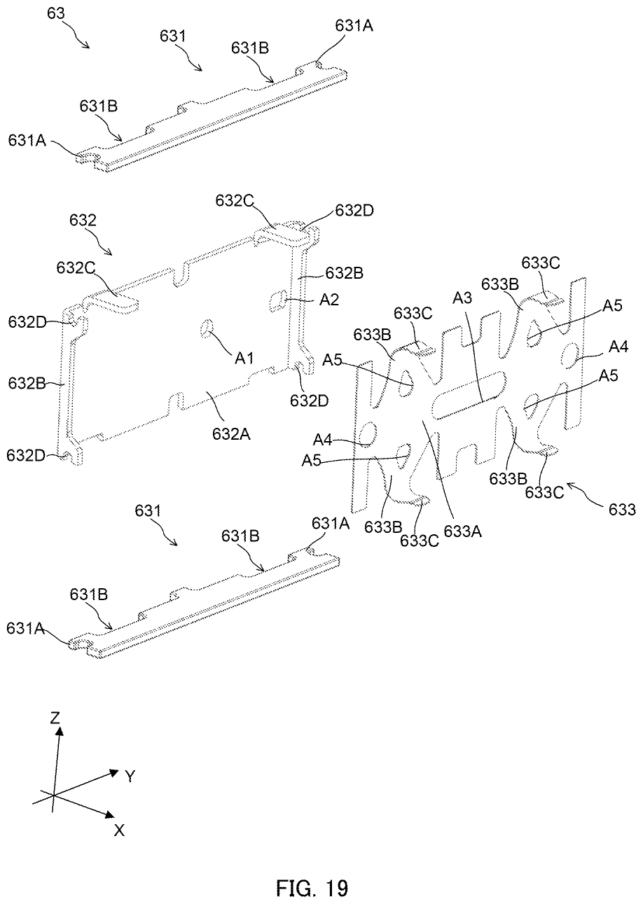

Next, a detailed description will be given of interposition part 63. FIG. 18 is a perspective view of interposition part 63. FIG. 19 is an exploded perspective view of interposition part 63.

As illustrated in FIG. 18, interposition part 63 is the thrust generation mechanism that generates the thrust to move the movable part in the direction of the optical axis, as mentioned above, and includes a pair of plate-shaped members 631, supporting member 632, and biasing member 633.

The pair of plate-shaped members 631 is a contacting part having a plane extending in the Y-direction (predetermined direction, the first direction) and is composed of, for example, a hard member made of a metal material such as titanium-copper, nickel-copper, or stainless steel.

The pair of plate-shaped members 631 is provided to clamp the pair of oscillators 641B composing resonant portion 641 of ultrasonic motor 64 from the +side and −side in the Z-direction (see FIG. 17 and the like).

In the pair of plate-shaped members 631, the plane portions are disposed substantially in parallel in the X-direction and the Y-direction so that resonant portion 641 and the plane portions can be in contact with each other. In addition, the thickness of plate-shaped member 631 is preferably set in consideration of durability when sliding with resonant portion 641 and the size, weight, and the like of lens driving part 60. As illustrated in FIG. 19, plate-shaped members 631 have a pair of axis portions 631A and a pair of recessed portions 631B.

A pair of axis portions 631A is a portion supported by supporting member 632 and is provided to protrude from opposite end portions of plate-shaped member 631 in the Y-direction. In the present embodiment, recesses are respectively formed in side surfaces of plate-shaped members 631 on the +side and the −side in the Y-direction, and, of the side wall portions including the recessed portions, the −side wall portions in the X-direction are designated as axis portions 631A. Further, an axis portion may be a protrusion from a side surface of a plate-shaped member, for example.

A pair of recessed portions 631B is a portion recessed from the side surface of plate-shaped member 631 on the −side in the X-direction toward the +side in the X-direction, and the recessed portions are respectively provided in the vicinity of the end portions of the side surface on the +side and the −side in the Y-direction.

Supporting member 632 is formed of, for example, a plate-shaped metal member and includes frame connecting part 632A, supporting portions 632B, and regulating parts 632C.

Frame connecting part 632A is configured in a rectangular shape and is disposed to be substantially in parallel in the Y-direction and the Z-direction. Frame connecting part 632A is connected to fourth portion 611D of frame 61 (see FIG. 11, FIG. 12, or the like) by an adhesive or the like, for example, and has holes A1 and A2 mentioned above.

Hole A1 is a portion through which protrusion D1 of fourth portion 611D of frame 61 is passed, and is provided in a substantially central portion of frame connecting part 632A. Hole A2 is a portion through which protrusion D2 of fourth portion 611D of frame 61 is passed, and is provided in the vicinity of the end portion of frame connecting part 632A on the +side in the Y-direction.

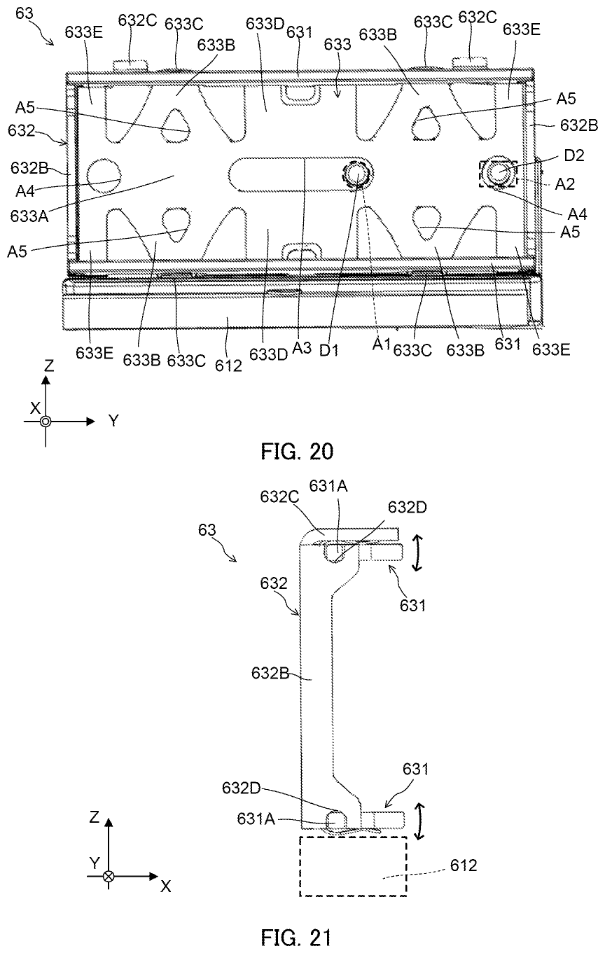

Note that hole A2 is configured to be wider in the Y-direction than hole A1. Thus, even when manufacturing tolerances or the like cause the displacement in the positional relationships between protrusions D1 and D2 and holes A1 and A2, respective protrusions D1 and D2 can be easily passed through holes A1 and A2 (see FIG. 20).

Supporting portions 632B are portions that turnably (movably) support the pair of plate-shaped members 631. Supporting portions 632B are formed by, for example, bending the opposite end portions of the plate-shaped metal member (frame connecting part 632A) in the Y-direction to the +side in the X-direction. Supporting portions 632B are respectively provided on the opposite end portions of frame connecting part 632A in the Y-direction.

On opposite end portions of each supporting portion 632B in the Z-direction, engaged portions 632D for engagement with axis portions 631A of each plate-shaped member 631 are provided. Engaged portions 632D are configured to be recessed from the opposite end portions of each supporting portion 632B in the Z-direction, and are provided at positions corresponding to respective axis portions 631A of the pair of plate-shaped members 631.

As illustrated in FIG. 21, engaged portions 632D each have a size allowing plate-shaped member 631 to turn about axis portion 631A when engaged with axis portion 631A. Thus, the pair of axis portions 631A of each plate-shaped member 631 is pivotably supported by engaged portions 632D of each supporting portion 632B on the both sides in the Y-direction, thereby allowing plate-shaped members 631 to turn about axis portions 631A.

Note that, in order to prevent axis portions 631A from being disengaged from the inside, engaged portions 632D are preferably formed such that the recession amount with respect to the side surfaces of supporting portions 632B in the Z-direction is set to a depth level longer than the thickness of axis portions 631A (plate-shaped members 631), for example.

Regulating parts 632C are provided on the +side in the Z-direction (opposite side to side in contact with resonant portion 641) with respect to one of plate-shaped member 631 on the +side in the Z-direction. Regulating parts 632C are configured to extend from a side surface of frame connecting part 632A on the +side in the Z-direction to the +side in the Z-direction and then to extend to the +side in the X-direction. Two regulating parts 632C are provided side by side in the Y-direction, and are provided at positions displaced in the Y-direction from engaging portions 633C to be described later.

Within the extent covering the portion where plate-shaped member 631 is disposed, regulating parts 632C are spaced from plate-shaped member 631 to an extent allowing a collision with plate-shaped member 631 when plate-shaped member 631 moves too far toward the +side in the Z-direction.

Providing regulating parts 632C in such a manner enables regulating parts 632C to regulate excessive movement of plate-shaped member 631 on the +side in the Z-direction toward the +side in the Z-direction. Consequently, even in a situation where a force more than required is applied to plate-shaped member 631 by application of an external force such as when camera module 1 is dropped, the excessive movement of plate-shaped member 631 is regulated by regulating parts 632C, and thus, it is possible to suppress the coming off of plate-shaped member 631 from supporting member 632.

Further, magnet holding portion 612 of frame 61 is provided on interposition part 63 on the −side in the Z-direction. Magnet holding portion 612 is spaced from plate-shaped member 631 to an extent allowing the collision with plate-shaped member 631 when plate-shaped member 631 on the −side in the Z-direction moves too far toward the −side in the Z-direction. Magnet holding portion 612 corresponds to the “regulating part” of the present invention.

Providing magnet holding portion 612 in such a manner enables magnet holding portion 612 to regulate excessive movement of plate-shaped member 631 on the −side in the Z-direction toward the −side in the Z-direction. Consequently, even in a situation where a force more than required is applied to plate-shaped member 631 by application of an external force such as when camera module 1 is dropped, the excessive movement of plate-shaped member 631 is regulated by magnet holding portion 612, and thus, it is possible to suppress the coming off of plate-shaped member 631 from supporting member 632.

Further, at a position corresponding to engaging portions 633C to be described later, magnet holding portion 612 is preferably disposed away from engaging portions 633C to such an extent that magnet holding portion 612 is positioned outside of the moving range (vibration range) of engaging portions 633C. In the manner described above, it is possible to suppress the obstruction of a biasing action of engaging portions 633C with respect to plate-shaped members 631.

As illustrated in FIGS. 19 and 20, biasing member 633 is a member for biasing each of the pair of plate-shaped members 631 toward resonant portion 641, and is formed of, for example, a plate-shaped metal member such as a leaf spring. Biasing member 633 is configured to be capable of clamping the pair of plate-shaped members 631 and includes biasing main-body portion 633A, arm portions 633B, and engaging portions 633C.

Biasing main-body portion 633A forms a plane portion extending in the Y-direction and the Z-direction and is disposed at a position facing frame connecting part 632A, between resonant portion 641 and frame connecting part 632A of supporting member 632.

Biasing main-body portion 633A has long hole A3 and a pair of holes A4. Long hole A3 is provided in a center of biasing main-body portion 633A in the Y-direction and is configured to be longer in the Y-direction than holes A4. The pair of holes A4 is respectively provided at opposite end portions of biasing main-body portion 633A in the Y-direction.

Long hole A3 is located at a position corresponding to protrusion D1 when supporting member 632 is bonded to frame 61. Long hole A3 is configured such that the edge thereof is not in contact with protrusion D1.

Of the pair of holes A4, hole A4 situated on the +side in the Y-direction is located at a position corresponding to protrusion D2 when supporting member 632 is bonded to frame 61. Hole A4 configured such that the edge does not touch the protruding portion D2.

Arm portions 633B are provided to protrude in the Z-direction from the positions corresponding regions between long hole A3 and holes A4 in respective opposite end portions of biasing main-body portion 633A in the Z-direction, and connects between engaging portions 633C to be described later and biasing main-body portion 633A.

In particular, arm portions 633B protrude one by one from the opposite end portions of biasing main-body portion 633A in the Z-direction, in the portion corresponding the region between hole A4 on the −side in the Y-direction and long hole A3. Further, arm portions 633B protrude one by one from the opposite end portions of biasing main-body portion 633A in the Z-direction, in the portion corresponding the region between hole A4 on the +side in the Y-direction and long hole A3. That is, four arm portions 633B, two from the end portion on the +side and two from the end portion on the −side of biasing main-body portion 633A in the Z-direction, are provided in total.

By providing arm portions 633B in such a manner, when force to bend arm portions 633B is applied with respect to biasing main-body portion 633A, a restoring force (biasing force) is generated which allows portions of arm portions 633B to return to the biasing main-body portion 633A side.

Further, each arm portion 633B is configured to be tapered from a connecting portion in between with biasing main-body portion 633A, and hole A5 is formed in a central portion in the vicinity of the connecting portion of arm portion 633B in the Y-direction. The size of hole A5 can be appropriately adjusted in accordance with the biasing force required by biasing member 633 and the strength of arm portion 633B.

Further, biasing main-body portion 633A is provided with protruding portions 633D protruding from a position corresponding to long hole A3 and protruding portions 633E protruding from positions corresponding to the pair of holes A4.

Engaging portions 633C are portions in contact with a surface of plate-shaped member 631 on a side opposite to resonant portion 641 (outer side in the Z-direction), and extend from tip end portions of respective arm portions 633B (end portions in the Z-direction) to the +side in the X-direction.

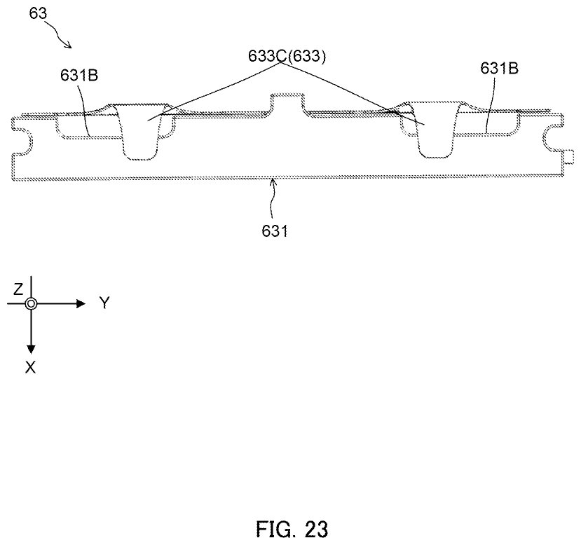

In other words, two (a pair of) engaging portions 633C corresponding to two arm portions 633B at the end portion on the −side in the Y-direction are disposed to clamp the pair of plate-shaped members 631, and are thus engaged with and brought into contact with each of the pair of plate-shaped members 631. Further, two (a pair of) engaging portions 633C corresponding to two arm portions 633B at the end portion on the +side in the Y-direction are disposed to clamp the pair of plate-shaped members 631, and are thus engaged with and brought into contact with each of the pair of plate-shaped members 631. That is, two pairs of (a plurality of pairs of) engaging portions 633C are provided side by side in the Y-direction (see also FIG. 23).

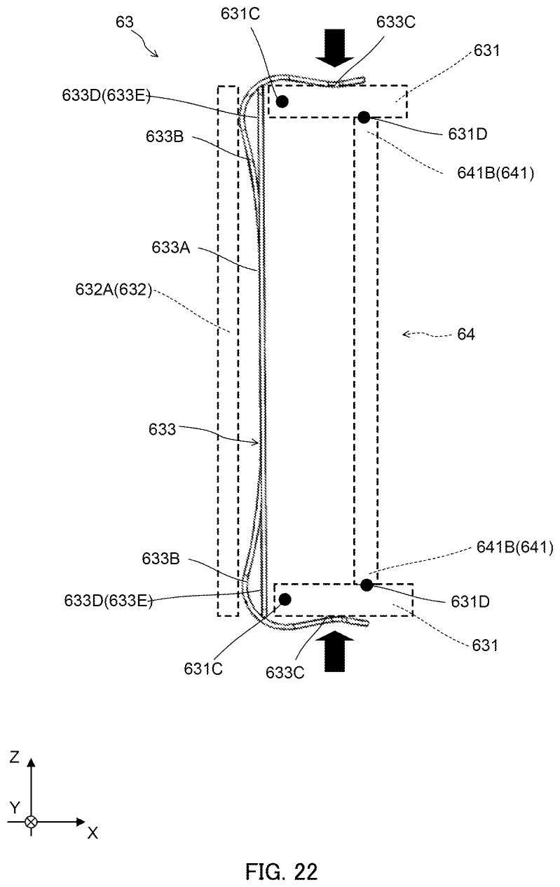

As illustrated in FIG. 22, the pair of engaging portions 633C clamps the pair of plate-shaped members 631; thus, arm portions 633B bend toward the −side in the X-direction with respect to biasing main-body portion 633A. As a result, a biasing force on the pair of engaging portions 633C to push the pair of plate-shaped members 631 into the resonant portion 641 side is generated, based on the restoring force on arm portions 633B toward the biasing main-body portion 633A side (see arrows). That is, biasing member 633 biases the pair of plate-shaped members 631 toward resonant portion 641.

Incidentally, a distance between the pair of plate-shaped members 631 is a distance allowing elastic deformations of respective arm portions 633B when the pair of plate-shaped members 631 is clamped by the pair of engaging portions 633C, and is appropriately set in accordance with the biasing force required by biasing member 633.

Thus, since plate-shaped members 631 are turnably supported by supporting member 632, when resonant portion 641 resonates, plate-shaped members 631 are moved in accordance with the resonance by being biased by biasing member 633. That is, biasing member 633 biases plate-shaped members 631 toward resonant portion 641 such that plate-shaped members 631 move in accordance with the resonance of resonant portion 641 and transmit the thrust to the movable part via supporting portions 632B.

Since plate-shaped members 631 extend in the Y-direction and are formed of a relatively hard member, biasing plate-shaped members 631 at the two positions by two pairs of engaging portions 633C enables application of a uniform biasing force to resonant portion 641 in the entire of plate-shaped members 631 in the Y-direction.

Thus, the biasing force can be equally applied in the Y-direction (moving direction of movable part) in the contact portion between an active element composed of resonant portion 641 and each plate-shaped member 631 (passive element) which relatively moves with respect to the active element. Consequently, the driving force of ultrasonic motor 64 can be stably transmitted to the movable part (second lens unit 32 or third lens unit 33) via interposition part 63.

Further, since plate-shaped members 631 are moved in accordance with the resonance of resonant portion 641, when plate-shaped members 631 and oscillators 641B slide against each other, the displacement of the positional relationship between them in the X-direction can be reduced. Consequently, the driving force of ultrasonic motor 64 can be further stably transmitted to the movable part. That is, in the present embodiment, it is possible to improve the stability of driving performance of ultrasonic motor 64.

Further, biasing member 633 is disposed in a state where the pair of engaging portions 633C clamp the pair of plate-shaped members 631 and without being fixed to supporting member 632 (frame connecting part 632A). In other words, biasing main-body portion 633A and arm portions 633B (connecting parts) of biasing member 633 are disposed in a free state with respect to supporting member 632 (member other than the pair of plate-shaped members 631).

Incidentally, the term “free state” herein refers to an unfixed state regardless of the presence or absence of contact with the member of interest (member other than the pair of plate-shaped members 631).

This enables operation of the entirety of biasing main-body portion 633A and arm portions 633B, which connects the pair of engaging portions 633C in the Z-direction, as a spring. For example, when the biasing main-body portion is disposed in a fixed manner to the supporting member, a biasing force is applied to the engaging portions by a portion not including the fixed portion of the biasing main-body portion.

Accordingly, for example, the manufacturing tolerances or the like cause the displacement of the fixed portion of the biasing main-body portion, and thereby, a length of each arm portion for generating a biasing force (including length from fixed position of biasing main-body portion to arm portion) also varies from a designed value. The designed value is, for example, a length of an arm portion when there is no displacement in the fixed portion of the biasing main-body portion. Therefore, in the pair of engaging portions, the biasing force adversely varies between the +side and −side in the Z-direction.

In contrast, in the present embodiment, since biasing main-body portion 633A and arm portions 633B are disposed in an unfixed manner with respect to supporting member 632, the length of each of biasing main-body portion 633A and arm portions 633B for generating a biasing force on engaging portions 633C does not vary.

As a result, the supposed biasing force can be applied to plate-shaped members 631. Further, the biasing force can be applied to plate-shaped members 631 equally on the +side and −side in the Z-direction, and thus, the accuracy of the biasing force by biasing member 633 can be improved, thereby further improving the driving performance of ultrasonic motor 64.

Further, since biasing main-body portion 633A and arm portions 633B are in the free state, operating the entirety of biasing main-body portion 633A and arm portions 633B as the spring allows the spring length to be lengthen as much as possible. As in the present embodiment, when plate-shaped members 631 that are relatively hard members are used, there is a need to increase the biasing force by biasing member 633 to some extent.

However, when the spring length is shortened while increasing the biasing force, a degree of stress applied to a spring part is increased. For example, in a case where the biasing main-body portion is fixed, the spring length in each engaging portion will be a length from the fixed position of the biasing main-body portion to the arm portion, which is extremely short compared to the entirety of the biasing main-body portion and the arm portions.

In contrast, in the present embodiment, the spring length of biasing member 633 can be lengthen as much as possible, so that the degree of stress applied to the entirety of biasing member 633 can be reduced. Consequently, it is possible to suppress a defect (e.g., damage) caused by the excessive stress applied to biasing member 633.

Further, in the X-direction (second direction perpendicular to direction along linear motion of frame 61 described above (Y-direction, the first direction) and perpendicular to biasing direction of biasing member 633), engaging portions 633C bias plate-shaped members 631 at positions between support points for plate-shaped members 631 in supporting member 632 (turning centers 631C of axis portions 631A) and contact points with plate-shaped members 631 in resonant portion 641.

In the manner described above, for example, it is possible to suppress the floating of axis portions 631A in plate-shaped members 631 in the case of biasing a position equivalent to the contacting points with plate-shaped members 631 in resonant portion 641.

As in the present embodiment, when plate-shaped members 631 that are relatively hard members are used, there is a need to increase the biasing force by biasing member 633 to some extent. Therefore, biasing a position where the axis portion 631A side does not float makes it easier to apply a strong biasing force.

Further, as illustrated in FIG. 23, two pairs of engaging portions 633C are preferably disposed symmetrically with respect to the central portions of plate-shaped members 631 in the Y-direction. This makes it easier for engaging portions 633C on both sides in the Y-direction to bias plate-shaped members 631 in the entire Y-direction, in a well-balanced and even manner.

Further, on the positions corresponding to engaging portions 633C in plate-shaped members 631, recessed portions 631B described above are formed. This makes it possible to suppress the displacement of biasing member 633 caused by contact of biasing member 633 with side surfaces of the plate-shaped members when biasing member 633 is assembled to the pair of plate-shaped members 631.

In the above-described embodiment, supporting member 632 turnably supports plate-shaped members 631, but the present invention is not limited to this case, and the supporting member may movably support the plate-shaped members to the +side and −side in the Z-direction, for example.

Further, in the above-described embodiment, supporting member 632 is configured to include engaged portions 632D with which axis portions 631A of plate-shaped members 631 are engaged, but the present invention is not limited to this case, and the supporting member may have any configuration as long as plate-shaped members 631 are movably supported.

In addition, in the above-described embodiment, biasing member 633 is provided between supporting member 632 and resonant portion 641, but the present invention is not limited to this case, and the biasing member may have any configuration and may be provided at any position as long as a plate-shaped member can follow a resonance of a resonant portion.

In the above-described embodiment, two pairs of engaging portions are provided, but the present invention is not limited to this case, and a single pair of engaging portions may be provided, or three or more pairs of engaging portions may be provided.

Further, in the above-described embodiment, plate-shaped members 631 and oscillators 641B are in contacted with each other, but from the viewpoint of abrasion resistance of a plate-shaped member (passive element), a coating layer such as diamond-like carbon or ceramic may be formed on a surface of the plate-shaped member. In a case where the ceramic is coated on plate-shaped members 631, the hardness of plate-shaped members 631 becomes, for example, equal to or more of the hardness of resonant portion 641, that is, becomes higher than the hardness of resonant portion 641.

Further, in the above-described embodiment, a configuration including two guide shafts is employed, but the present invention is not limited to this case. The present invention may have a configuration having, for example, three or more guide shafts. The present invention may also have a configuration including a single guide shaft.

In the above-described embodiment, support shafts 50 are provided on both sides in the X-direction, but the present invention is not limited to this, and support shaft 50 may be provided on only one side in the X-direction.

In the above-described embodiment, side wall portion 11 and bottom wall portion 12 of housing 10 are formed by insert molding. However, the present invention is not limited to this, and the bottom wall portion may be adhesively fixed to side wall portion 11.

Further, the above-described embodiment employs the configuration having two movable lenses composed of second lens unit 32 and third lens unit 33, but the present invention is not limited to this, and the configuration may have a single movable lens, or three or more movable lenses.

Further, the above-described embodiment employs the configuration having four lens units, but the present invention is not limited to this, and any number of lens units may be provided as long as the configuration has at least one movable lens. In addition, in the case of a configuration including one movable lens, the number of lens driving parts is also one.

In the above-described embodiment, interposition part 63 is formed by bending a plate-like metal member, but the present invention is not limited to this case, and the main body portion and the engaging portion that compose the interposition part may be formed by separate members.

In the above-described embodiment, frame 61 and supporting member 632 of interposition part 63 are formed by separate members, but the present invention is not limited to this. For example, frame 61 and supporting member 632 may be integrally formed.

In the above-described embodiment, each of connecting parts 62 connecting together frame 61 and the lens unit is configured with the spring member, but the present invention is not limited to this, and the connecting part may be configured with any member as long as it is a member having elasticity.

Further, in the above-described embodiment, third portion 611C of frame 61 is disposed to be spaced apart from second guide shaft 82, but the present invention is not limited to this, and a configuration may also be used in which the third portion may also support the second guide shaft.

The above-described embodiment has the configuration in which the bottom wall portion includes the bent portions or half punches, but the present invention is not limited to this, and a configuration may also be used in which the bottom wall portion does not include any bent portion or half punch.

In the above-described embodiment, resonant portion 641 includes two oscillators 641B, but the present invention is not limited to this, and the present invention may have a configuration in which the resonant portion includes one oscillator, for example. In this case, however, one plate-shaped member is provided.

In the above-described embodiment, the drive control part, the reflection drive control part, and the image capturing control part are provided separately, but the present invention is not limited to this, and at least two of the drive control part, the reflection drive control part, and the image capturing control part may be composed of one control part.

Further, although bearing portion 114A is provided in the above embodiment, the present invention is not limited to this, and the present invention does not have to be provided with any bearing portion.

For example, while a smartphone serving as a camera-equipped mobile terminal has been described in the above embodiment as an example of the camera-mounted device including camera module 1, the present invention is applicable to a camera-mounted device including a camera module and an image processing part that processes image information obtained by the camera module. The camera-mounted device encompasses an information apparatus and a transporting apparatus. Examples of the information apparatuses include a camera-equipped mobile phone, a note-type personal computer, a tablet terminal, a mobile game machine, a web camera, a drone, and a camera-equipped in-vehicle device (e.g., a rear-view monitor device or a drive recorder device). In addition, examples of the transporting apparatuses include an automobile, a drone.

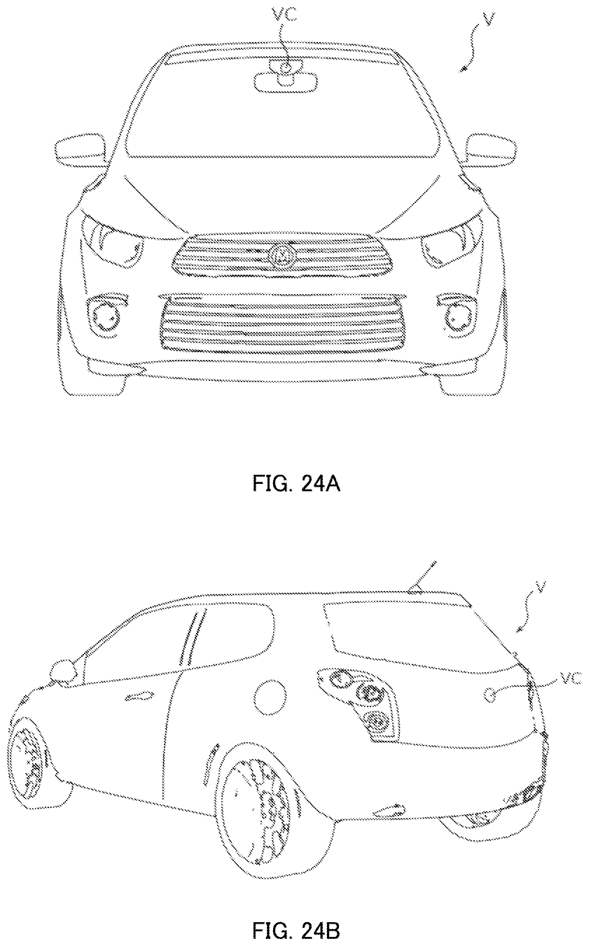

FIGS. 24A and 24B each illustrate automobile V serving as the camera-mounted device in which in-vehicle camera module VC (Vehicle Camera) is mounted. FIG. 24A is a front view of automobile V, whereas FIG. 24B is a rear perspective view of automobile V. In automobile V, camera module 1 described in the embodiment is mounted as in-vehicle camera module VC. As illustrated in FIGS. 24A and 24B, in-vehicle camera module VC may, for example, be attached to the windshield so as to face forward, or to the rear gate so as to face backward. In-vehicle camera module VC is used for rear monitoring, drive recording, collision avoidance control, automatic drive control, and the like.

In addition, the above-described embodiments merely describe examples of implementations for practicing the present invention, and should not be construed as limiting the technical scope of the present invention. That is, the present invention can be embodied in various forms without departing from the spirit, scope, or principal features of the present invention. For example, the shape, size, number, and material of each part described in the above embodiment are merely examples, and can be changed as appropriate.

The disclosure of U.S. provisional Patent Application No. 63/113,224, filed on Nov. 13, 2020, including the specification, drawings and abstract is incorporated herein by reference in its entirety.

### INDUSTRIAL APPLICABILITY

The driving unit according to the present invention is useful as a driving unit, a lens driving device, a camera module, and a camera-mounted device each capable of improving the stability of driving performance of an ultrasonic motor.

### REFERENCE SIGNS LIST

1 Camera module
10 Housing
11 Side wall portion
12 Bottom wall portion
20 Reflection driving part
21 Reflecting housing
22 Mirror
23 Reflection drive control part
30 Lens part
31 First lens unit
32 Second lens unit
32A Main body portion
32B Supported portion
33 Third lens unit
33A Main body portion
33B Supported portion
34 Fourth lens unit
34A Protruding portion
40 Image capturing part
50 Support shaft
60 Lens driving part
61 Frame
62 Connecting part
63 Interposition part
64 Ultrasonic motor
70 Position detection part
80 Guide part
81 First guide shaft
82 Second guide shaft
100 Drive control part
111 First wall
111A Placement portion
111B Engaged portion
111C Board placement portion
112 Second wall
112A Supporting portion
112B Placement portion
112C Guide supporting portion
112D Opening portion
113 Third wall
113A Bridging portion
113B Supporting portion
113C Guide supporting portion
114 Fourth wall
114A Bearing portion
121 Positioning portion
122 Bent portion
123 Half punch
200 Image capturing control part
611 Guided portion
611A First portion
611B Second portion
611C Third portion
611D Fourth portion
612 Magnet holding portion
614 Magnet part
631 Plate-shaped member
631A Axis portion
631B Recessed portion
632 Supporting member
632A Frame connecting part
632B Supporting portion
632C Regulating part
633 Biasing member
633A Biasing main-body portion
633B Arm portion
633C Engaging portion
633D Protruding portion
633E Protruding portion
641 Resonant portion
641A Body portion
641B Oscillator
641C Protruding portion
641D Energization portion
642 Piezoelectric element
643 First electrode
643A Clamping portion
643B Electrode part
644 Second electrode

What is claimed is:

1. A driving unit for generating a thrust to move a movable part in a predetermined direction, the driving unit comprising:
an ultrasonic motor that includes a piezoelectric element and a resonant portion and is configured to convert a vibration of the piezoelectric element into a linear motion, the piezoelectric element generating the vibration, the resonant portion resonating with the vibration of the piezoelectric element;
a contacting part that is in contact with the resonant portion;
a supporting portion that is connected to the movable part and is configured to support the contacting part; and
a biasing portion that is engaged with the contacting part and is configured to bias the contacting part toward the resonant portion such that the contacting part moves in accordance with resonance of the resonant portion and transmits the thrust to the movable part via the supporting portion.

2. The driving unit according to claim 1, wherein the supporting portion turnably supports the contacting part.

3. The driving unit according to claim 1, wherein:
the contacting part includes a pair of plate-shaped members that is disposed such that a pair of oscillators composing the resonant portion is positioned between the pair of plate-shaped members, and
the biasing portion includes:
a pair of engaging portions that is disposed such that the pair of plate-shaped members is positioned between the pair of engaging portions, the pair of engaging portions being configured to engage with the pair of plate-shaped members, respectively, and
a connecting part that is disposed in a free state with respect to a member other than the pair of plate-shaped members and is configured to connect between the pair of engaging portions such that a biasing force is generated on the pair of engaging portions.

4. The driving unit according to claim 3, wherein:
the contacting part extends in a first direction that is along a direction of the linear motion,
a plurality of the pairs of engaging portions is provided side by side in the first direction, and
the plurality of pairs of engaging portions is disposed symmetrically with respect to a center of the pair of plate-shaped members in the first direction.

5. The driving unit according to claim 1, wherein:
the contacting part extends in a first direction that is along a direction of the linear motion, and
the biasing portion is engaged with the contacting part at a position between a support point for the contacting part in the supporting portion and a contact point with the contacting part in the resonant portion, in a second direction perpendicular to the first direction and perpendicular to a biasing direction of the biasing portion.

6. The driving unit according to claim 1, further comprising a regulating part provided on an opposite side to the resonant portion with respect to the contacting part and being configured to regulate a movement of the contacting part toward the opposite side.

7. A lens driving device, comprising:
a movable part that is capable of holding a movable lens; and
the driving unit according to claim 1 that is configured to drive the movable part in a predetermined direction.

8. The lens driving device according to claim 7, wherein:
the movable part includes a first movable part and a second movable part that are disposed in the predetermined direction and are configured to hold a first movable lens and a second movable lens, respectively,
the driving unit includes a first driving unit and a second driving unit that drive the first movable part and the second movable part in the predetermined direction, respectively,
the first driving unit includes a first ultrasonic motor including a first piezoelectric element and a first resonant portion and is configured to generate, based on a drive of the first ultrasonic motor, a thrust to move the first movable part in the predetermined direction, and
the second driving unit includes a second ultrasonic motor including a second piezoelectric element and a second resonant portion and is configured to generate, based on a drive of the second ultrasonic motor, a thrust to move the second movable part in the predetermined direction.

9. A camera module, comprising:
the lens driving device according to claim 7;
a lens part that includes the movable lens held by the movable part; and
an image capturing part that is configured to capture a subject image imaged by the lens part, wherein
the movable lens is driven in the predetermined direction.

10. A camera-mounted device that is an information apparatus or a transporting apparatus, the camera-mounted device comprising:
the camera module according to claim 9; and
an image capturing control part that processes image information obtained by the camera module.
